(19) United States
(12) Patent Application Publication
(10) Pub. No.: US 2011/0314017 A1
(43) Pub. Date: Dec. 22, 2011

(54) TECHNIQUES TO AUTOMATICALLY MANAGE SOCIAL CONNECTIONS

(75) Inventors: Eran Yariv, Zichron (IL); Kfir Karmon, Petach Tikva (IL)

(73) Assignee: MICROSOFT CORPORATION, Redmond, WA (US)

(21) Appl. No.: 12/818,360

(22) Filed: Jun. 18, 2010

(51) Int. Cl. G06F 17/30

(52) U.S. Cl. 707/737; 707/748; 707/736; 707/E17.089

(57) ABSTRACT

Techniques to manage social connections are described. An apparatus may comprise a processor communicatively coupled to a memory. The memory may be arranged to store a social analysis component that when executed by the processor is operative to receive a list of members in a social network, receive at least one relationship indicator derived from multiple member attributes of a member, and generate a social identifier based on the relationship indicator, the social identifier representing a social connection type for a social connection or potential social connection between two or more members of the list of members in the social network. Other embodiments are described and claimed.

### BACKGROUND

Social networking systems allow social networks to be developed between individuals through an online platform using various types of networking and communications technologies. A social network is in general a social structure made of individuals or organizations which are connected by one or more specific types of interdependency, such as friendship, kinship, common interest, financial exchange, dislike, beliefs, knowledge, and so forth. Social network analysis views social relationships in terms of network theory consisting of nodes and connections. Nodes are the individual actors within the networks, and connections (or ties) are the relationships between the actors. Nodes and connections may be illustrated to form a social graph. There can be many kinds of connections between the nodes.

In the past, a social networking system (SNS) may be used to define a group or collection of members, sometimes referred to informally as “friends,” having some form of relationship through direct or indirect connections. However, social networks are expanding in size and complexity over time. As such, social graphs for an average social network have evolved into highly complex structures, with many nodes and connections between nodes. Current social networking systems are limited in defining and describing various attributes of nodes and connections between nodes in these more complex structures, and therefore are incapable of accurately reflecting nuances of an actual physical social network in a virtual manner. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques to automatically manage social connections. Some embodiments are particularly directed to techniques to automatically identify, recommend or classify social connections for a social networking system (SNS). Embodiments may monitor various member attributes of members within a given SNS to generate social identifiers for social connections or potential social connections between various members. The social identifiers may strongly identify certain characteristics of a particular social connection, such as a social connection type as defined by a managed taxonomy for a SNS. The social identifiers may be useful for a variety of purposes, such as recommending potential social connections and/or classifying certain social connections.

In one embodiment, for example, an apparatus such as a computing device may comprise a processor communicatively coupled to a memory. The memory may be arranged to store a social analysis component that when executed by the processor is operative to receive a list of members in a social network, receive at least one relationship indicator derived from multiple member attributes of a member, and generate a social identifier based on the relationship indicator, the social identifier representing a social connection type for a social connection or potential social connection between two or more members of the list of members in the social network. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a first social networking system.

FIG. 2 illustrates an embodiment of a second social networking system.

FIG. 3 illustrates an embodiment of a distributed system for the first or second social networking systems.

FIG. 4 illustrates an embodiment of a centralized system for the first or second social networking systems.

FIG. 5 illustrates an embodiment of a logic flow for a social analysis component.

FIG. 6 illustrates an embodiment of a logic flow for a social monitor component.

FIG. 7 illustrates an embodiment of a computing architecture for elements of the first or second social networking systems.

FIG. 8 illustrates an embodiment of a communications architecture for elements of the first or second social networking systems.

### DETAILED DESCRIPTION

Various embodiments are directed to techniques to automatically manage social connections for a SNS, such as a SNS implemented as a web service over a network. Embodiments may monitor various member attributes of members within a given SNS to generate social identifiers for social connections between various members. The social identifiers may strongly identify certain characteristics of a particular social connection, such as a social connection type as defined by a managed taxonomy for a SNS. The social identifiers may be generated using various attributes or properties associated with one or more members, such as explicitly defined metadata for members, communications between members, interests, activities, behavior patterns, locations, other social connections, types of social connections, subscriptions to SNS, multimedia information for members (e.g., an image, photograph or video), and any other member attributes or properties consistent with the embodiments.

The social identifiers may be useful for a variety of purposes, such as classifying and recommending social connections. With respect to classification, for instance, the social identifiers may be used to provide a higher level of confidence when attempting to automatically or manually classify a social connection within traditional categories provided by a SNS, such as “friends” or “family.” In another example, the social identifiers may be used to provide finer levels of classifications and distinctions of a social connection with a higher degree of granularity well beyond conventional classifications. For instance, the social identifiers may identify certain social connection types as defined by a managed taxonomy for a SNS. The managed taxonomy may include managed vocabulary terms identifying many different types of social connection types appropriate for a given SNS, thereby allowing a SNS to more accurately represent nuances of social connections in a social network for its members. As a result of enhanced classifications, a member may communicate and publish information to other related members of a social network in a more directed and focused manner. With respect to recommendations, for instance, the social identifiers may be used to identify potential social connections between members with a higher degree of confidence due to a scoring system that uses multiple member attributes. This is superior to other mechanical recommendation systems utilizing conventional techniques such as connection counts or connection groupings, partly due to the robustness and diversity of member attributes or properties used in determining whether to recommend a potential social connection. As such, the social identifiers may allow more reliable recommendations for potential social connections which may be of greater value to a member. As a result, the embodiments can improve affordability, scalability, modularity, extendibility, or interoperability for an operator, device or network.

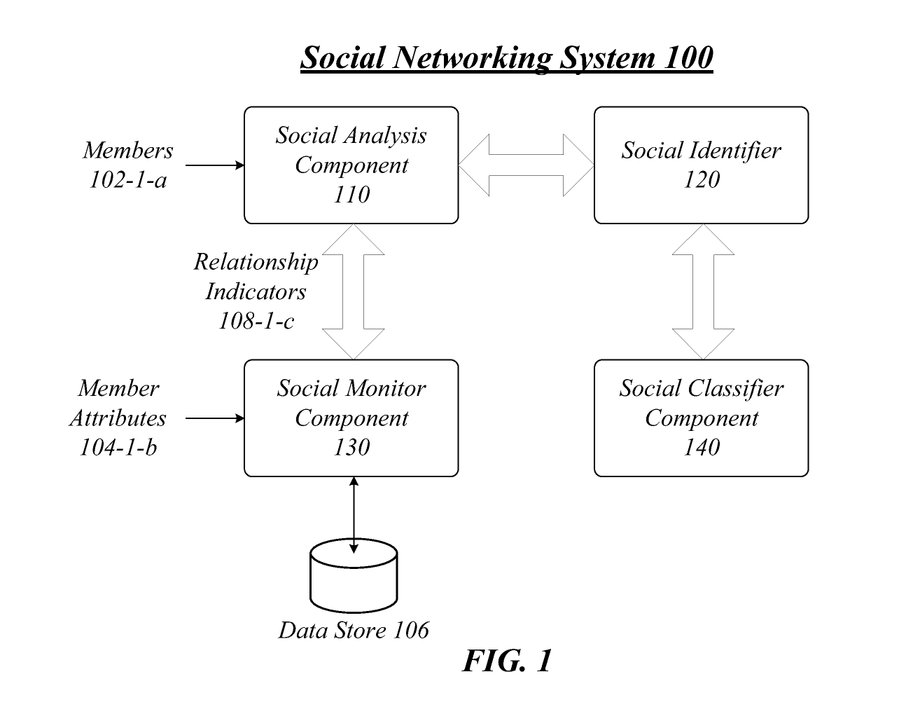

FIG. 1 illustrates a block diagram for a social networking system 100 to manage social connections for a SNS. In one embodiment, for example, the social networking system 100 may comprise a computer-implemented social networking system 100 having multiple components 110, 130 and 140. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the social networking system 100 may be implemented as part of an electronic device, or by multiple electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the social networking system 100 as shown in FIG. 1 has a limited number of elements in a certain topology, it may be appreciated that the social networking system 100 may include more or less elements in alternate topologies as desired for a given implementation.

The components 110, 130 and 140 may be communicatively coupled via various types of communications media. The components 110, 130 and 140 may coordinate operations between each other. The coordination may involve the uni-directional or bi-directional exchange of information. For instance, the components 110, 130 and 140 may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The social networking system 100 may generally comprise any application or service provided to establish an electronic or online social network between members of the social networking system 100. The social networking system 100 may provide an online software platform accessible via a network to publish, distribute, disseminate, share or otherwise communicate information between related members over the network. Examples for the social networking system 100 may include without limitation MICROSOFT® WINDOWS LIVE®, MYSPACE®, FACEBOOK®, LINKEDIN®, TWITTER®, BEBO® and other social networking systems and services consistent with the described embodiments. The embodiments are not limited in this context.

The social networking system 100 may include various members subscribing to various applications or services provided by the social network system 100. Some of the members may create formal social connections between each other to become related members, thereby forming an online social network for the related members. What precisely constitutes a formal social connection may depend on a particular set of definitions provided by a given social networking system. In general, a formal social connection for the social networking system 100 may comprise a defined relationship between members giving some level of permission to access information authored by related members, such as binary content (e.g., messages, pictures, videos, and other multimedia information) published by related members. Such related members are sometimes referred to informally as “friends” or “buddies.” In some cases, for example, the defined relationship may comprise a dyadic relationship. A dyadic relationship may refer to two or more members of a group having an ongoing relationship or interaction, such as friends in the social networking system 100.

In the illustrated embodiment shown in FIG. 1, the social networking system 100 may comprise a set of components used to automatically manage social connections, including a social analysis component 110, a social monitor component 130 and a social classifier component 140. The social networking system 100 is limited to the illustrated set of components for purposes of clarity. It may be appreciated that the social networking system 100 may include other components typical for a social networking system, such as messaging components to communicate information, security components to authenticate members, storage components to store binary objects for members (e.g., a user tile with a photograph of a member), and other components providing applications or services consistent with a social networking system.

In various embodiments, the social networking system 100 may comprise the social analysis component 110. The social analysis component 110 may be generally arranged to analyze online social networks comprising members of the social networking system 100. The social networking system 100 may comprise members subscribing to services and/or applications provided by the social networking system 100. One purpose of the social networking system 100 is to establish a social network with other members within the social networking system 100. Typically a social network is constructed by searching for other members having a common interest or activity. For instance, a member may search for other members within the social networking system 100 based on contact information from a contact application. This type of search is based on a premise that if the member has contact information for another member subscribing to the social networking system 100, then the member has some form of relationship already established with the other member that can be used as a basis to establish a formal social connection as defined by the social networking system 100. The member may then decide whether to add the other member as a formal social connection in the social networking system 100, thereby making the other member a related member.

The social analysis component 110 may be arranged to receive a list of members 102-1-a that are members subscribing to any services and/or applications provided by the social networking service 100. It is worthy to note that “a” and “b” and “c” and similar designators as used herein are intended to be variables representing any positive integer. Thus, for example, if an implementation sets a value for a=5, then a complete list of members 102-1-a may include members 102-1, 102-2, 102-3, 102-4 and 102-5. The embodiments are not limited in this context.

In one embodiment, the members 102-1-a may comprise a data set including any number of members within the social networking service 100. In one embodiment, the members 102-1-a may comprise a data subset of members from the overall data set of members of the social networking service 100. A data subset may be generated using any type of filtering criteria, such as all members within a geographic location for a base member, for example. In some cases, the members 102-1-a may have formal social connections already defined between certain members. For instance, a member 102-1 may manually designate a member 102-2 as a social connection type of “Friend.” In other cases, the members 102-1-a may not have any social connections defined between members.

The social analysis component 110 may determine whether the members 102-1-a have a previously established social connection based on multiple relationship indicators 108-1-c. The social analysis component 110 may receive relationship indicators 108-1-c from a social monitor component 130. In one embodiment, the relationship indicators 108-1-c may each represent a relationship score for a different social connection type. The social networking system 100 may implement a managed taxonomy or set of vocabulary terms representing different categories or types of relationships for its members 102-1-a. In one embodiment, for example, the managed taxonomy may comprise a hierarchical set of managed vocabulary terms. A particular managed taxonomy, however, may vary according to a given implementation of the social networking system 100. For purposes of illustration and not limitation, assume the social networking system 100 has a managed taxonomy of social connection types as shown in Table 1, as follows:

TABLE 1

| Relationship Indicator | Social Connection Type |
|---|---|
| 108-1 | Friend |
| 108-2 | Personal Friend |
| 108-3 | Business Friend |
| 108-4 | Family Friend |
| 108-5 | Family |
| 108-6 | Neighbors |
| 108-7 | Politics |
| 108-8 | Sports |
| 108-9 | Clubs |

As indicated in Table 1, each relationship indicator 108-1 through 108-9 may be assigned a different social connection type. Some of the relationship indicators 108-1 through 108-9 are for social connection types identified using a non-hierarchical set of managed vocabulary terms. For instance, the relationship indicator 108-5 for the social connection type of “Family” is a non-hierarchical vocabulary term, as well as the social connection types of the relationship indicators 108-6, 108-7, 108-8 and 108-9. Some of the relationship indicators 108-1 through 108-9 are for social connection types identified using a hierarchical set of managed vocabulary terms. For instance, the relationship indicator 108-1 of the social connection type “Friend” is a parent vocabulary term for the children vocabulary terms “Personal Friend” and “Business Friend” represented by the respective relationship indicators 108-2, 108-3.

Each of the relationship indicators 108-1 to 108-9 may be assigned a relationship score by the social monitor component 130. In one embodiment, a relationship score may comprise a probability value representing a probability of a relationship of the given social connection type. The social analysis component 110 may use the relationship indicators 108-1-c to analyze and recognize patterns indicative of a social connection, and a social connection type, between any of the members 102-1-a.

In one embodiment, a relationship indicator 108-1-c may be assigned a relationship score indicating a formal social connection has been previously defined between two or more members 102-1-a. For instance, assume the social analysis component 110 receives a relationship indicator 108-1 with a relationship score of 100% (or 1.0) indicating a formal social connection in a category of “Friend” has been previously defined between two or more members 102-1-a, such as members 102-1, 102-2, for example. In this case, the social analysis component 110 may generate a social identifier 120 indicating a social connection type of “Friend” presently exists between the members 102-1, 102-2.

The social analysis component 110 may generate a social identifier 120 for the social connection only in those cases where the members have a formally defined social connection for the social networking service 100. Once the social analysis component 110 validates a presence of a social connection between members 102-1-a, the social analysis component 110 may attempt to further qualify or refine a characteristic for a social connection useful for specific classification of the social connection using one or more of the relationship indicators 108-1-c. Continuing with our example above, if the relationship indicator 108-1 comprises a relationship score indicating presence of a social connection type of “Friend” between members 102-1, 102-2, then the social analysis component 110 may use relationship indicators 108-2, 108-3 . . . 108-9 to identify other hierarchical social connection types between the members 102-1, 102-2, such as “Personal Friend” or “Business Friend,” or non-hierarchical social connection types such as “Family” or “Neighbor.” The social analysis component 110 may then output one or more social identifiers 120 representing a code or value for the different social connection types. In some cases, the social analysis component 110 may output multiple social identifiers 120 for a single social connection between the members 102-1, 102-2, thereby providing multiple options for recommendation and/or classification operations of the social networking system 100.

In various embodiments, the social networking system 100 may comprise the social monitor component 130. The social monitor component 130 may be generally arranged to monitor various types of electronic information for the social networking system 100 pertinent to any of the members 102-1-a. In one embodiment, the social monitor component 130 may receive information about the members 102-1-a in the form of multiple member attributes 104-1-b. The social monitor component 130 may store previously received information about the members 102-1-a in the data store 106 for historical and trend analysis.

The social monitor component 130 may receive a list of member attributes 104-1-b for one or more members 102-1-a of the social networking system 100. A member attribute 104-1-b may comprise any information associated with a member 102-1-a that may be measured and accessed by the social networking system 100, or another device or system communicatively coupled to the social networking system 100. Examples for a member attribute 104-1-b may include without limitation member metadata (e.g., name, address, contact information, defined metadata tags, labels, etc.), communications, communication characteristics (e.g., time, number, frequency, etc.), communication modalities (e.g., email, instant message, wall message, comments, short message service, multimedia message service, etc.), preferences, interests, behaviors, activities, mutual activities, frequency of mutual activities, locations, relationships, time intervals of relationships, number of relationships, schools, businesses, memberships (e.g., social networks, clubs, professional organizations, etc.), and so forth. Some embodiments may provide examples utilizing a few member attributes 104-1-b as described below. It may be appreciated, however, that any number of member attributes 104-1-b may be utilized in any combination as desired for a given implementation. The embodiments are not limited in this context.

The social monitor component 130 may generate one or more relationship scores derived from each of the member attributes 104-1-b, and may generate multiple relationship indicators 108-1-c with the relationship scores. In one embodiment, a relationship score may represent a probability of a relationship of a given social connection type between the members 102-1-a. In one embodiment, a relationship score may further represent a weight for a given social connection type. Relationship indicators 108-1-c and relationship scores may be used to represent other characteristics of a social relationship as well. The embodiments are not limited in this context.

The social monitor component 130 may analyze the member attributes 104-1-b, and generate one or more relationship indicators 108-1-c from a set of member attribute 104-1-b associated with each of the members 102-1-a. Each of the relationship indicators 108-1-c may represent a relationship score. In one embodiment, a relationship score may comprise a probability value calculated by the social monitor component 130. For instance, each relationship indicator 108-1-c for a given social connection between a set of members 102-1-a may be assigned a relationship score between 0-100% (or 0.0-1.0). Further, each relationship indicator 108-1-c for a given social connection between a set of members 102-1-a may represent a different social connection type. For instance, as illustrated in Table 1, a relationship indicator 108-1 may be for a general social connection type of “Friend,” while relationship indicators 108-2, 108-3 may be for more specific social connection types of respective “Personal Friend” and “Business Friend.” The social monitor component 130 may output the various relationship indicators 108-1-c to the social analysis component 110. The social analysis component 110 may receive the relationship indicators 108-1-c, and use the relationship scores of the relationship indicators 108-1-c to determine an appropriate social identifier 120 for the members 102-1-a.

In one embodiment, the social monitor component 130 may receive a member attribute 104-1 comprising common metadata for the members 102-1-a, and generate a relationship indicator 108-1 from the member attribute 104-1. For instance, assume the members 102-1, 102-2 are related members having a social connection. Further assume the members 102-1, 102-2 have indicated to the social networking system 100 that the social connection is of a class labeled as “Friend.” The social networking system 100 may generate metadata (e.g., metadata tags) with values and/or parameters indicating that the members 102-1, 102-2 are friends with each other, and store the values and/or parameters as the member attribute 104-1. The social monitor component 130 may receive the member attribute 104-1, interpret the member attribute 104-1 as explicitly defining a formal social connection of a type “Friend,” and generate the relationship indicator 108-1 with a value and/or parameter indicating a social connection type of “Friend.” For instance, the relationship indicator 108-1 representing an amount of common metadata may have a relationship score of 100% (or 1.0), thereby indicating an absolute probability that the members 102-1, 102-2 have a social connection type of “Friend.” In this case, it is a relatively straight-forward translation between the member attribute 104-1 and the relationship indicator 108-1, with little or no analysis of the member attribute 104-1 to generate the relationship indicator 108-1. However, it may be appreciated that the single relationship indicator 108-1 provides very little information regarding properties of the social connection between the members 102-1, 102-2, such as whether the members 102-1, 102-2 have a personal relationship or a business relationship.

The social monitor component 130 may receive other types of common metadata via the member attribute 104-1. For instance, the members 102-1, 102-2 may define metadata such as personal information, favorite interests and/or activities, communication preferences, names of binary objects such as images and photographs and videos, contact information (e.g., name, address, phone number, email address, IM address, etc.), websites, web logs (blogs), books, music, sports, hobbies, schools, jobs, and any other types of metadata defined by a member for a social networking system. The social monitor component 130 may analyze metadata for each of the members 102-1, 102-2 to find common occurrences of metadata. For example, assume the members 102-1, 102-2 both are fans of a common sports team. The social monitor component 130 may generate a relationship indicator 108-7 with a relationship score of 50% (or 0.5), thereby indicating a probability that the members 102-1, 102-2 have a social connection type of “Sport.”

In one embodiment, the social monitor component 130 may generate one or more relationship indicators 108-1-c from member attribute 104-1-b of the list of members 102-1-a, including a member attribute 104-2 comprising common communications of the members 102-1-a. The social monitor component 130 may monitor and store communications for the members 102-1-a received as a member attribute 104-2. Continuing with the previous example, assume that the social monitor component 130 receives a member attribute 104-2 comprising one or more communications between the members 102-1, 102-2. The social monitor component 130 may receive the communications or information about the communications as indicated by the member attribute 104-2, and store the communications information as part of the data store 106. The social monitor component 130 may statistically analyze the stored communications information to determine that the members 102-1, 102-2 typically send a mean average of x messages per day for normal business days, and 2x messages during weekend days. From this statistical measure, the social monitor component 130 may infer a higher level of personal relationship between the members 102-1, 102-2 over a business relationship. In this case, the social monitor component 130 may generate a relationship indicator 108-2 representing a relationship score for a “Personal Friend.” The social monitor component 130 may assign the relationship indicator 108-2 a relationship score of 50% (or 0.5) indicating a probability of the members 102-1, 102-2 having a social connection type of “Personal Friend.”

A relationship score for a given relationship indicator 108-1-c may be increased or decreased based on further analysis. For the relationship indicator 108-2, for example, assume the social monitor component 130 determines that the members 102-1, 102-2 typically send a mean average of x messages per day for normal business days, 2x messages during weekend days, and 4x messages during holidays. In this case, the social monitor component 130 may increase the relationship score for the relationship indicator 108-2 from 50% (or 0.5) to 75% (or 0.75) indicating a higher probability that the members 102-1, 102-2 have a social connection type of “Personal Friend.” Alternatively, assume the social monitor component 130 statistically analyzes the stored communications to determine that the members 102-1, 102-2 typically send a mean average of x messages per day for normal business days, and x-y messages during weekend days. From this statistical measure, the social monitor component 130 may infer a lower level of personal relationship between the members 102-1, 102-2, and a higher level of business relationship. In this case, the social monitor component 130 may generate a relationship score of 10% (or 0.1) for the relationship indicator 108-2. At the same time, the social monitor component 130 may generate a relationship score of 50% (or 0.5) for a relationship indicator 108-3 representing a probability that the members 102-1, 102-2 have a social connection type of “Business Friend.”

In one embodiment, the social monitor component 130 may generate one or more relationship indicators 108-1-c from member attribute 104-1-b of the list of members 102-1-a, including a member attribute 104-3 comprising common interests of the members 102-1-a. For instance, assume the members 102-1, 102-2 both subscribe to Really Simple Syndication (RSS) feeds to a same political blog. The social monitor component 130 may generate a relationship score of 50% (or 0.5) for a relationship indicator 108-7 indicating a probability that the members 102-1, 102-2 have a social connection type of “Politics.”

In one embodiment, the social monitor component 130 may generate one or more relationship indicators 108-1-c from member attribute 104-1-b of the list of members 102-1-a, including a member attribute 104-4 comprising common activities of the members 102-1-a. For instance, assume the members 102-1, 102-2 both hold offices in a same professional organization. The social monitor component 130 may generate a relationship score of 50% (or 0.5) for a relationship indicator 108-8 indicating a probability that the members 102-1, 102-2 have a social connection type of “Clubs.”

In one embodiment, the social monitor component 130 may generate one or more relationship indicators 108-1-c from member attribute 104-1-b of the list of members 102-1-a, including a member attribute 104-5 comprising common locations for the members 102-1-a. For instance, assume the members 102-1, 102-2 both live in a same neighborhood. The social monitor component 130 may generate a relationship score of 90% (or 0.8) for a relationship indicator 108-6 indicating a probability that the members 102-1, 102-2 have a social connection type of “Neighbors.”

It may be appreciated that the member attributes 104-1-b and relationship indicators 108-1-c described above are merely a few illustrative examples and are not meant to be an exhaustive list of examples. Examples for other member attributes 104-1-b may include without limitation member metadata (e.g., name, address, contact information, defined metadata tags, labels, etc.), communications, communication characteristics (e.g., time, number, frequency, etc.), communication modalities (e.g., email, instant message, wall message, comments, short message service, multimedia message service, etc.), preferences, behaviors, mutual activities, frequency of mutual activities, other relationships, time intervals of relationships, number of relationships, schools, businesses, memberships (e.g., social networks, clubs, professional organizations, etc.), and so forth. A particular set of member attributes 104-1-b and relationship indicators 108-1-c implemented for a given social networking system 100 may vary in accordance with various design parameters and performance constraints. The embodiments are not limited in this context.

The social analysis component 110 may receive the one or more relationship indicators 108-1-c from the social monitor component 130 and use the relationship scores of the one or more relationship indicators 108-1-c to determine one or more social identifiers 120 for the members 102-1-a. In one embodiment, each social identifier 120 may represent an actual social connection type for the social connection between the members 102-1-a, as opposed to a relationship score indicating a probability of a social connection type as provided by the relationship indicators 108-1-c.

The social analysis component 110 may receive multiple relationship indicators 108-1-c for a social connection between a given set of members 102-1-a, such as the members 102-1, 102-2. The social analysis component 110 may evaluate the relationship indicators 108-1-c alone or in some combination to determine one or more social identifiers 120 identifying a social connection type for the social connection between the members 102-1-a. For instance, assume the social analysis component 110 receives the relationship indicator 108-1 with a 70% relationship score. As previously described, the relationship indicator 108-1 may be for a social connection type of “Friend.” The social analysis component 110 may evaluate the relationship score of 70% for the relationship indicator 108-1, such as by comparing the relationship score of 70% to a defined threshold value in a lookup table (LUT), and output a social identifier 120 with a code or value representing a social connection type of “Friend” when the relationship score is equal to or greater than the defined threshold value in the LUT. An example of information stored in a LUT may be provided using Table 2, as follows:

TABLE 2

| Relationship | Social Connection | Defined Threshold | Social Identifier |
|---|---|---|---|
| Indicator | Type | Value | 120 |
| 108-1 | Friend | 60% | 001 |
| 108-2 | Personal Friend | 80% | 002 |
| 108-3 | Business Friend | 70% | 003 |
| 108-4 | Family Friend | 70% | 004 |
| 108-5 | Family | 90% | 005 |
| 108-6 | Neighbors | 90% | 006 |
| 108-7 | Politics | 50% | 007 |
| 108-8 | Sports | 50% | 008 |
| 108-9 | Clubs | 50% | 009 |

As shown in Table 2, the relationship indicator 108-1 is for a social connection type of “Friend,” and the defined threshold value for a relationship score to indicate the social connection type of “Friend” is 60%. In the previous example, if the relationship indicator 108-1 has a relationship score of 70%, which is greater than the defined threshold value of 60% for the relationship indicator 108-1, the social analysis component 110 may output a social identifier 120 with a value of “001” representing the social connection type of “Friend.”

The defined threshold values and social identifier 120 values as shown in Table 2 may be set at any values as desired for a given implementation. In one embodiment, the defined threshold values may be set based on negative consequences in cases of incorrect identification of a social connection type. For instance, a user may not have a strong emotional response if a member is erroneously assigned a social connection type of “Business Friend,” and therefore a lower defined threshold value may be set for the relationship indicator 108-3. However, a user may have an extremely strong emotional response if a member is erroneously assigned a social connection type of “Family,” and therefore a higher defined threshold value may be set for the relationship indicator 108-5.

The social analysis component 110 may also generate additional social identifiers 120 identifying other social connection types between the members 102-1-a. For instance, assume the social analysis component 110 receives the relationship indicator 108-2 with a 75% relationship score. As previously described, the relationship indicator 108-2 may be for a social connection type of “Personal Friend.” Since the relationship indicator 108-2 has a relationship score of 75%, which is greater than the defined threshold value of 70% for the relationship indicator 108-2, the social analysis component 110 may output a social identifier 120 with a value of “002” representing the social connection type of “Personal Friend.” In this case, the social analysis component 110 may output two social identifiers 120 for the social connection between the members 102-1, 102-2, the first social identifier 120 having a value of “001” indicating a social connection type of “Friend,” and a second social identifier 120 having a value of “002” indicating a social connection type of “Personal Friend.” Since the social connection type of “Personal Friend” is a child social connection type of the parent social connection type “Friend” in a hierarchical relationship, a single social identifier 120 with a value of “002” may be output in lieu of the social identifier 120 with a value of “001” as desired for a given implementation.

In addition to using a single relationship indicator 108-1-c to generate a social identifier 120, the social analysis component 110 may use a combination of multiple relationship indicators 108-1-c to generate a social identifier 120. In one embodiment, the social analysis component 110 may use multiple relationship indicators 108-1-c for members 102-1, 102-2 to increase confidence in selection of an accurate social identifier 120. For instance, assume the relationship indicator 108-1 for a social connection type of “Friend” has a relationship score of 50%, which is below the defined threshold value of 60% associated with the relationship indicator 108-1. Further assume the relationship indicator 108-6 for the social connection type “Neighbors” has a relationship score of 80%, which is below the defined threshold value of 90% associated with the relationship indicator 108-6. Although each of the relationship scores for the relationship indicators 108-1, 108-6 alone are insufficient to generate a social identifier 120 of “Friend” or “Neighbors,” the social analysis component may implement fuzzy logic to evaluate that each of the relationship scores are near the respective defined threshold values, and that “Neighbors” are typically a “Friend,” and therefore the combination of the relationship indicator 108-1, 108-2 provides an increased probability that the members 102-1, 102-2 actually have a social connection type of “Friend.” The social analysis component 110 may then output a social identifier 120 with a value “001” representing a social connection type of “Friend.”

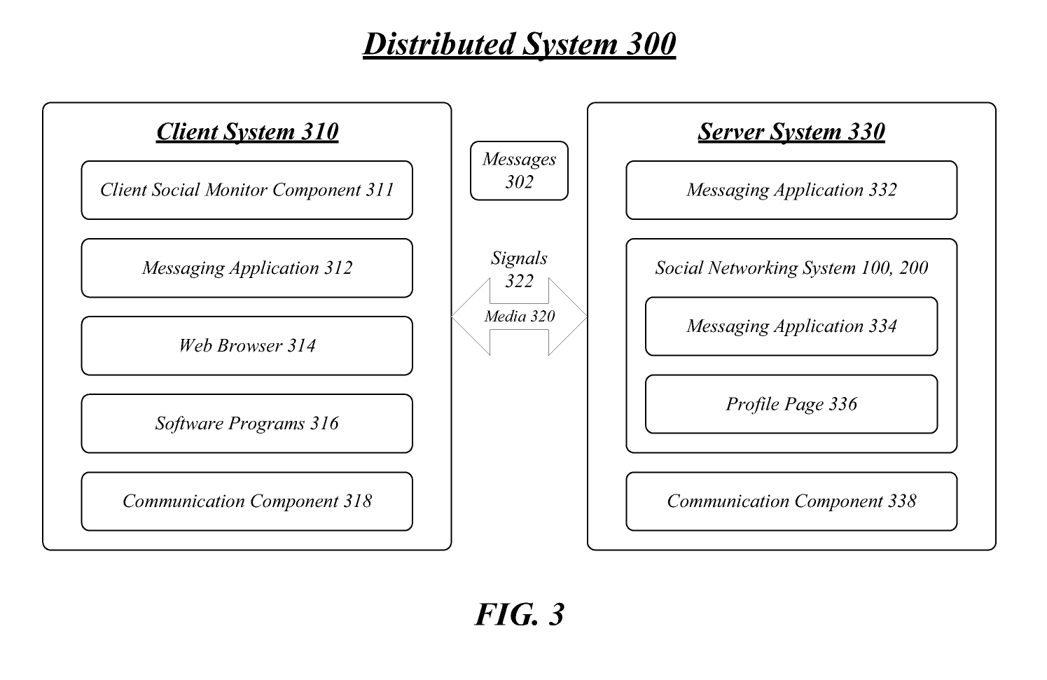

In various embodiments, the social networking system 100 may comprise the social classifier component 140. The social classifier component 140 may be generally arranged to classify various social connections between the members 102-1-a based on one or more social identifiers 120. The social classifier component 140 may receive one or more social identifiers 120 for one or more social connections between sets of members 102-1-a, and use the social identifiers to place the members 102-1-a into certain classes. For instance, the social classifier component 140 may classify certain members 102-1-a for access to certain applications and/or services provided by the social networking system 100 based on the social connection type indicated by the social identifier 120, such as displaying social connections on a profile page, publishing information to certain lists of social connections, setting permissions for media albums or media channels based on social connections, and so forth. The social classifier component 140 and its associated classifying operations may be described in more detail later below with reference to FIG. 3.

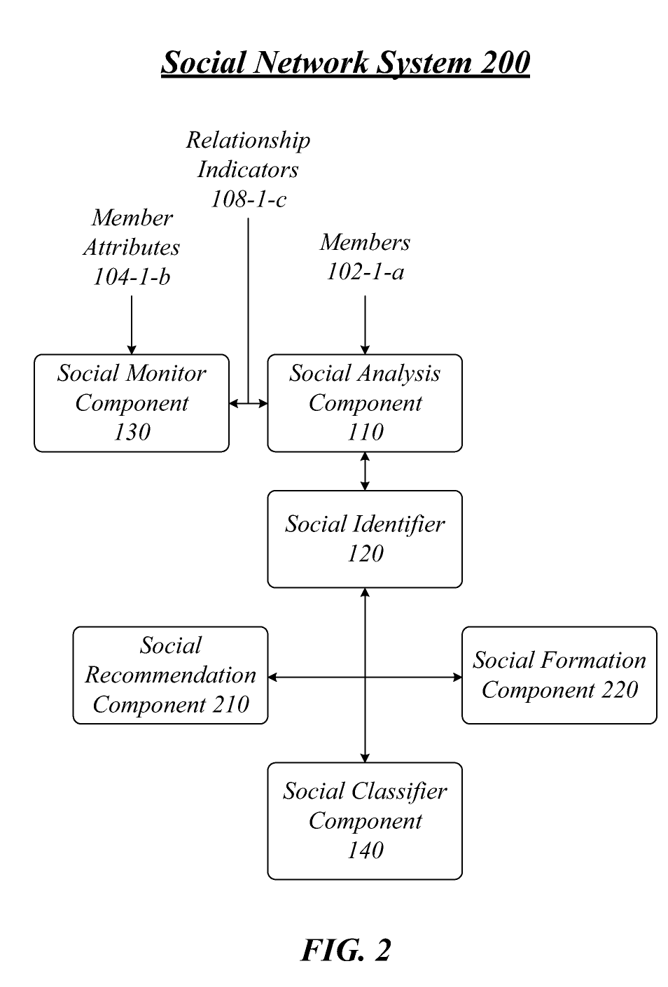

FIG. 2 illustrates a block diagram of a social networking system 200. The system 200 may be similar to the social networking system 100, and may further comprise a social recommendation component 210 and a social formation component 220.

The social recommendation component 210 may be arranged to determine whether the members 102-1-a have a potential social connection based on a social identifier 120. As previously described, the social analysis component 110 and the social monitor component 130 may interoperate to determine whether a set of members 102-1-a have a formal social connection. For instance, the social monitor component 130 may receive the member attribute 104-1 with metadata for the members 102-1, 102-2 explicitly indicating a social connection between the members 102-1, 102-2. In some cases, however, there may not be any social connection between the members 102-1, 102-2. In such cases, the social monitor component 130 may output various relationship indicators 108-1-c derived from the member attributes 104-1-b that may be used as a basis for determining a potential social connection between the members 102-1, 102-2.

The robustness and diversity of the member attributes 104-1-b, and the enhanced scoring system used for the relationship indicators 108-1-c based on analysis (e.g., statistical analysis) of the diverse member attributes 104-1-b, allows the social analysis component 110 to more accurately identify potential social connections relative to conventional techniques. For instance, in a previous example it was assumed the relationship indicator 108-1 for a social connection type of “Friend” has a relationship score of 50%, which is below the defined threshold value of 60% associated with the relationship indicator 108-1. It was further assumed the relationship indicator 108-6 for the social connection type “Neighbors” has a relationship score of 80%, which is below the defined threshold value of 90% associated with the relationship indicator 108-6. Each of the relationship scores for the relationship indicators 108-1, 108-6 alone are insufficient to generate a social identifier 120 of “Friend” or “Neighbors.” Despite these shortcomings, the social analysis component 110 may implement fuzzy logic to evaluate that each of the relationship scores are near the respective defined threshold values, and that “Neighbors” are typically a “Friend,” and therefore the combination of the relationship indicator 108-1, 108-2 provides an increased probability that the members 102-1, 102-2 actually have a social connection type of “Friend.” The social analysis component 110 may combine relationship scores for the relationship indicators 108-1, 108-2 to output a social identifier 120 with a value “001” representing a social connection type of “Friend.”

At this point, however, the social network system 200 may not be 100% certain that the member 102-2 is actually of a social connection type of “Friend.” Rather than making an erroneous assumption and automatically identify a social connection type of “Friend,” the social classifier component 140 may route the social identifier 120 to the social recommendation component 210. The social recommendation component 210 may receive the social identifier 120 with the value “001,” and present a recommendation to create a social connection based on the potential social connection and the social identifier 120. The recommendation may be presented via a user interface view with information sufficient for the member 102-1 to make a decision regarding whether to add the member 102-2 as a social connection type “Friend.” The social recommendation component 210 may receive a control directive from the member 102-1 indicating the potential social connection with the member 102-2 should be converted to a social connection type “Friend.”

The social formation component 220 may be arranged to receive a potential social connection based on a social identifier 120. The social formation component 220 may then convert the potential social connection to a social connection type as indicated by the social identifier 120. The social formation component 220 may send confirmation to the social classifier component 140 that a social connection type as indicated by the social identifier 120 has been created, and the social classifier component 140 may then classify the newly formed social connection type using its classification operations.

FIG. 3 illustrates a block diagram of a distributed system 300. The distributed system 300 may distribute portions of the structure and/or operations for the systems 100, 200 across multiple computing entities. Examples of distributed system 300 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, for example, the distributed system 300 may be implemented as a client-server system. A client system 310 may implement a portion of the social networking systems 100, 200 such as a client social monitor component 311. The client system 310 may also implement a messaging application 312, a web browser 314, one or more software programs 316, and a communication component 318. A server system 330 may implement a messaging application 332, one or both social networking systems 100, 200 and a communications component 338. The social networking systems 100, 200 may further comprise a messaging application 334 and a profile page 336.

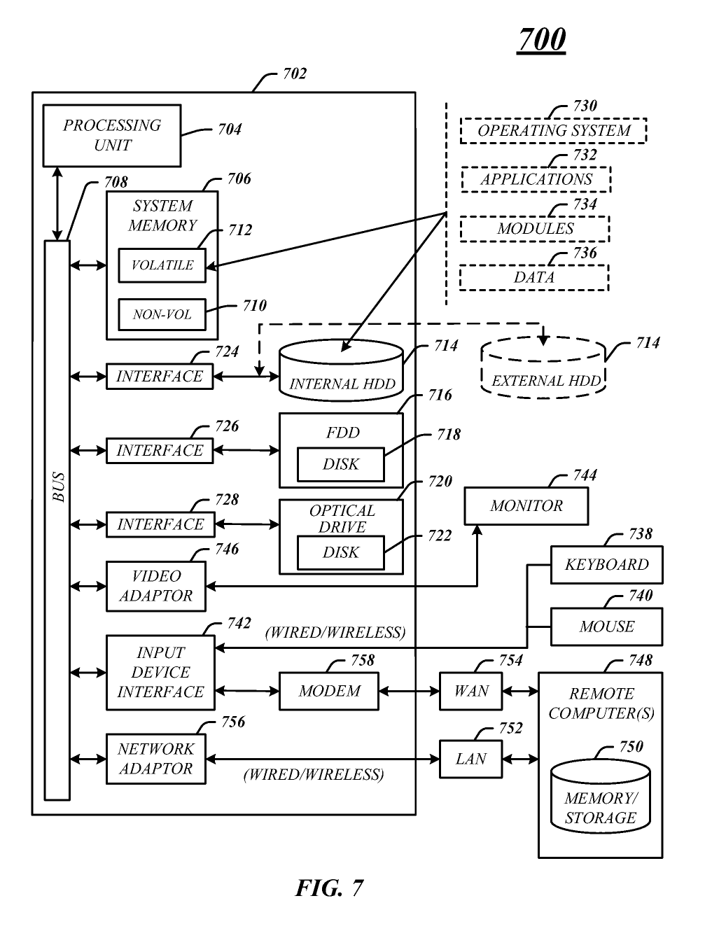

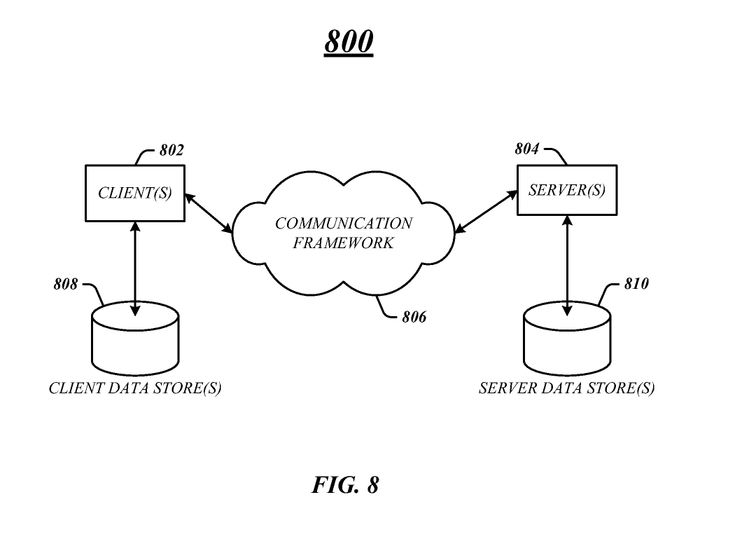

The client system 310 and the server system 330 may communicate with each over a communications media 320 using communications signals 322 via the communications components 318, 348. In one embodiment, for example, the communications media may comprise a public or private network. In one embodiment, for example, the communications signals 322 may comprise wired or wireless signals. Computing aspects of the client system 310 and the server system 330 may be described in more detail with reference to FIG. 7. Communications aspects for the distributed system 300 may be described in more detail with reference to FIG. 8.

In various embodiments, the client system 310 may implement the client social monitor component 311. In one embodiment, the client social monitor component 311 may be similar to the social monitor component 130 of the social networking systems 100, 200. In this case, the client social monitor component 311 may perform operations similar to those of the social monitor component 130 by monitoring various member attributes 104-1-b of a member 102-1-a utilizing the client system 310, generating various relationship indicators 108-1-c from the member attributes 104-1-b, and sending the relationship indicators 108-1-c to the social networking systems 100, 200. In one embodiment, the client social monitor component 311 may be designed to monitor various member attributes 104-1-b of a member 102-1-a utilizing the client system 310, and send the member attributes 104-1-b to the social networking systems 100, 200 for conversion to relationship indicators 108-1-c. The embodiments are not limited in this context.

In various embodiments, the client system 310 may comprise the messaging application 312. The messaging application 312 may comprise any type of messaging application, such as a unified messaging (UM) application, an e-mail application, a voicemail application, an instant messaging (IM) application, a group IM application, presence application, audio-video conferencing application, short message service (SMS) application, multimedia message service (MMS) application, and/or other types of communications and/or messaging programs, applications, or services in accordance with the described embodiments.

In various embodiments, the client system 310 may comprise a web browser 314. The web browser 314 may comprise any web browser suitable for use in accessing web applications provided by the server system 330. Examples of suitable web browsers may include MICROSOFT INTERNET EXPLORER®, GOOGLE® CHROME and APPLE® SAFARI, to name just a few. The embodiments are not limited in this context.

In various embodiments, the client system 310 may comprise various software programs 316. The software programs 316 may comprise any programs and services implemented by the client system 310, including without limitation system programs, operating systems, application programs, business application programs, search applications, document management programs, weblogs (blogs), word processing programs, spreadsheet programs, database programs, drawing programs, document sharing programs, message applications, web services, web applications, web services, web feeds such as really simple syndication (RSS), web browsers, SNS programs, gaming programs, and/or other types of programs, applications or services.

In various embodiments, the server system 330 may comprise or employ one or more server computing devices and/or server programs that operate to perform various methodologies in accordance with the described embodiments. For example, when installed and/or deployed, a server program may support one or more server roles of the server computing device for providing certain services and features. Exemplary server systems 330 may include, for example, stand-alone and enterprise-class server computers operating a server OS such as a MICROSOFT OS, a UNIX® OS, a LINUX® OS, or other suitable server-based OS. Exemplary server programs may include, for example, communications server programs as such as the messaging application 332, which may be implemented as a MICROSOFT WINDOWS LIVE® or MICROSOFT OFFICE COMMUNICATIONS SERVER (OCS) for managing incoming and outgoing messages, messaging server programs such as MICROSOFT EXCHANGE SERVER for providing unified messaging (UM) for e-mail, voicemail, VoIP, instant messaging (IM), group IM, enhanced presence, and audio-video conferencing, and/or other types of programs, applications, or services in accordance with the described embodiments.

In the illustrated embodiment shown in the distributed system 300, the social networking systems 100, 200 may further implement a messaging application 334 to allow members 102-1-a to communicate with each other. In one embodiment, the messaging applications 332, 334 may be implemented as separate applications and/or services. In one embodiment, the messaging applications 332, 334 may be implemented as a single unified messaging application. The latter embodiment may be desirable when the social networking systems 100, 200 are combined or implemented as a single application and/or service with the messaging applications 332, 334, such as MICROSOFT WINDOWS LIVE, for example. The social networking systems 100, 200 may also provide a profile page for each of the members 102-1-a of the social networking systems 100, 200.

In general operation, a member 102-1-a (e.g., the member 102-1) may utilize the messaging application 312 of the client system 310 to communicate various messages 302 with or through the messaging application 332 to other members 102-1-a of the social networking system 100, 200 (e.g., the member 102-2). Additionally or alternatively, the member 102-1 may utilize the web browser 314 to access the messaging application 332 of the server system 330 and/or the messaging application 334 of the social networking systems 100, 200 communicate various messages 302.

In one embodiment, the client social monitor component 311 may monitor the messages 302 (or message statistics of the messages 302) as the member attribute 104-2, and store the messages 302 (or message statistics of the messages 302) in the data store 106. The client social monitor component 311 may then analyze the messages 302 (or message statistics of the messages 302), and generate a relationship indicator 108-1-c based on the analysis.

In one embodiment, the client social monitor component 311 may also monitor other activities of the member 102-1 as implemented through the client system 310. For instance, the client social monitor component 311 may monitor web sites visited by the member 102-1 utilizing the web browser 314 as a member attribute 104-6, and any associated statistics for the web site visits (e.g., duration, intervals, interactions, advertisements, click-throughs, and so forth), and store a list of visited web sites in the data store 106. The client social monitor component 311 may then analyze the web site visits (or visit statistics), and generate a relationship indicator 108-1-c based on the analysis.

In one embodiment, the client social monitor component 311 may also monitor the software programs 316 utilized by the member 102-1, and any associate statistics regarding use of the software programs 316. For instance, the member 102-1 may utilize a software program 316 comprising a gaming program. The client social monitor component 311 may monitor use of the gaming program as a member attribute 104-7, including associated statistics such as a number of uses, duration of each use, awards, profiles, lists for friends or buddies, identifiers, communications, communications modalities, and other gaming information. The client social monitor component 311 may store the gaming information in the data store 106. The client social monitor component 311 may then analyze the gaming information, and generate a relationship indicator 108-1-c based on the analysis.

In one embodiment, the client social monitor component 311 may also monitor other software programs 316 utilized by the member 102-1 and implemented by the client system 310. For example, many online applications and/or services have a stand-alone software program 316 designed for execution by the client system 310 to facilitate interaction with the online versions of the applications and/or services. For instance, the client system 310 may implement a software program 316 designed for interaction with various social networking services, such as MICROSOFT WINDOWS LIVE, MYSPACE, FACEBOOK, LINKEDIN, TWITTER, BEBO, and other social networking services consistent with the described embodiments. The client system 310 may also implement a software program 316 designed for interaction with various image hosting and video hosting web service, such as WINDOWS LIVE PHOTO GALLERY, FLICKR®, SHUTTERFLY®, YOUTUBE®, and so forth. The client social monitor component 311 may monitor use of these programs as a member attribute 104-8, including any associated statistics such as a number of uses, duration of each use, awards, profiles, lists for friends or buddies, identifiers, communications, communications modalities, and other information. The client social monitor component 311 may store this information in the data store 106. The client social monitor component 311 may then analyze the information, and generate a relationship indicator 108-1-c based on the analysis. In this manner, the social networking systems 100, 200 may utilize information regarding activities of other social networking systems and/or media publishing systems used by the member 102-1, for use with more accurately identifying, recommending and classifying social connections for the members 102-1-a of the social networking systems 100, 200.

Once the social analysis component 110 generates one or more social identifiers for a social connection or potential social connection between members 102-1-a, the social classifier component 140 may use the social identifiers to place the members 102-1-a into certain classes. For instance, assume a social identifier 120 has a value of “005” indicating that the member 102-1 has a social connection type of “Family” with the member 102-2. Further assume that the member 102-1 has a distribution list for family photographs that is restricted to family members only. The social classifier component 140 may receive the social identifier 120 with the value of “005,” and add the member 102-2 to the distribution list for family photographs. Whenever the member 102-1 publishes a new photograph to a media album, as part of a media channel, or to the profile page 336, the messaging application 334 may distribute the new photograph to the member 102-2. In another example, assume the member 102-1 has a profile page 336 presenting a list of family members under the heading of “Family” and a list of friends under the heading “Friends.” Further assume the member 102-2 is currently presented under the heading of “Friends.” The social classifier component 140 may receive the social identifier 120 with the value of “005,” and add the member 102-2 to the list of family members under the heading of “Family.” The social classifier component 140 may automatically perform any number of classification operations consistent with a social networking system 100 using the social identifiers as desired for a given implementation. The embodiments are not limited in this context.

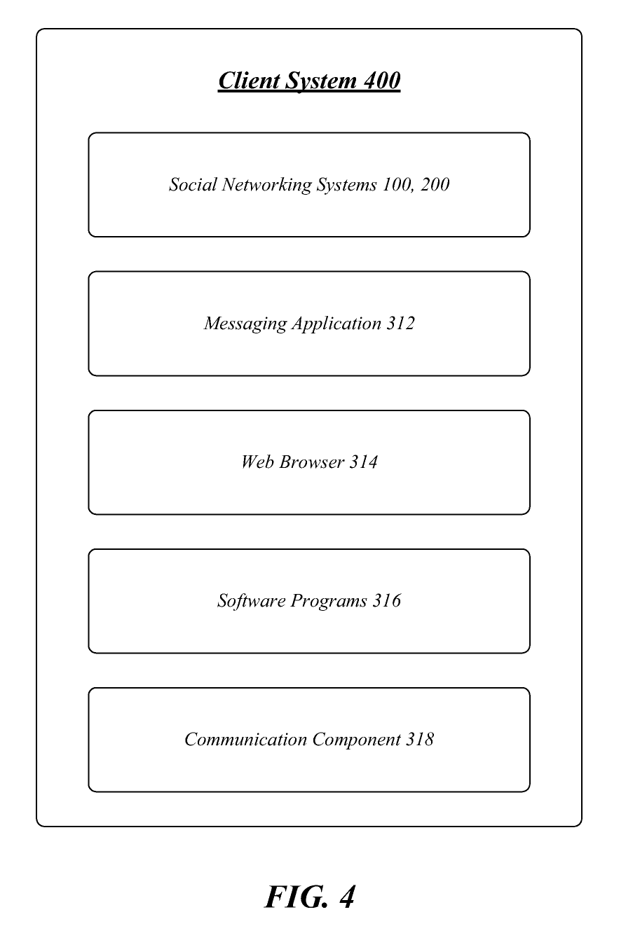

FIG. 4 illustrates a block diagram of a centralized client system 400. The client system 400 may implement all of the structure and/or operations for the systems 100, 200 in a single computing entity. In one embodiment, for example, the client system 400 may implement the structure and/or operations for the systems 100, 200 entirely within a single computing device. In the illustrated embodiment shown in FIG. 4, the client system 400 may be similar to the client system 310 as described with reference to FIG. 3. However, the client system 400 may replace the client social monitor component 311 with the entire social networking systems 100, 200. In this case, the social networking systems 100, 200 may manage social connections on behalf of a member 102-1-a, such as the member 102-1, utilizing the client system 400. Any information generated by the social networking systems 100, 200, including the member attributes 104-1-b, the relationship indicators 108-1-c, the social identifier 120, and any classification decisions made based on the social identifier 120, may be used locally to manage social connections for the member 102-1, or be sent via the messaging application 312 or any transports provided by the communication component 318 to a remote device for processing by the remote device (e.g., another client system or server system). The embodiments are not limited in this context.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

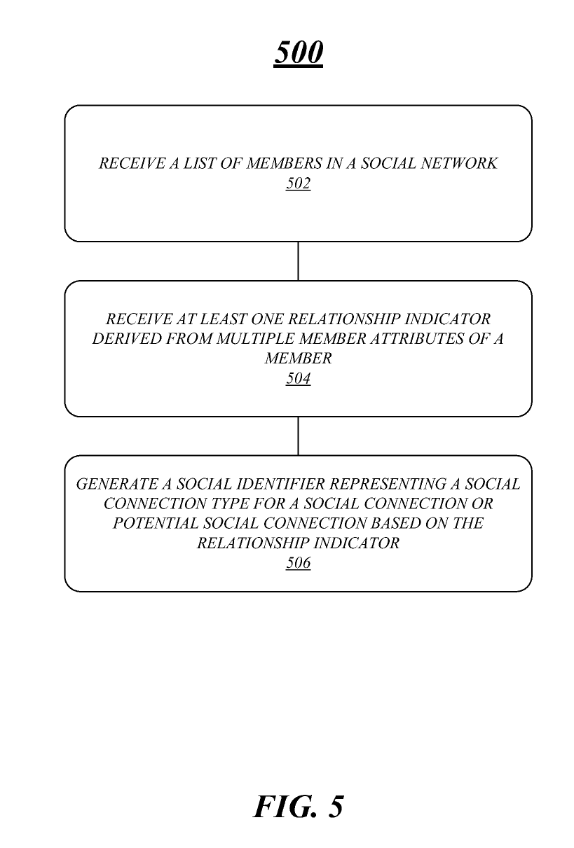

FIG. 5 illustrates one embodiment of a logic flow 500. The logic flow 500 may be representative of some or all of the operations executed by one or more embodiments described herein, such as the social analysis component 110 of the social networking systems 100, 200, for example.

In the illustrated embodiment shown in FIG. 5, the logic flow 500 may receive a list of members in a social network at block 502. For example, the social analysis component 110 may receive a list of members 102-1-a in a social network. In one embodiment, the list of members 102-1-a may comprise members which have previously subscribed to applications and/or services offered by the social networking systems 100, 200. In one embodiment, the list of members 102-1-a may comprise members which have not previously subscribed to applications and/or services offered by the social networking systems 100, 200. For instance, the members 102-1-a may comprise members from different social networking systems, some of which may be members of the social networking systems 100, 200. The list of members 102-1-a may comprise, for example, the members 102-1, 102-2, although other members may be on the list of members 102-1-a as well. The embodiments are not limited in this context.

The logic flow 500 may receive at least one relationship indicator derived from multiple member attributes of a member at block 504. For example, the social analysis component 110 may receive one or more relationship indicators 108-1-c derived from multiple member attributes 104-1-b of one or both members 102-1, 102-2. In one embodiment, the social analysis component 110 may receive one relationship indicator 108-1 derived from multiple member attributes 104-1-b of one or both members 102-1, 102-2. In one embodiment, the social analysis component 110 may receive two or more relationship indicators 108-1 derived from multiple member attributes 104-1-b of one or both members 102-1, 102-2. The embodiments are not limited in this context.

The logic flow 500 may generate a social identifier representing a social connection type for a social connection or potential social connection based on the relationship indicator at block 506. For example, the social analysis component 110 may generate one or more of the social identifiers 120 each representing a social connection type for a social connection or potential social connection based on the relationship indicator 108-1-c. In one embodiment, the social connection types may be defined using a managed taxonomy of vocabulary terms, an example of which is shown in Table 1. In one embodiment, the social connection types may be defined using a managed taxonomy of vocabulary terms organized in a hierarchical manner. The social identifiers 120 may be used by the social classifier component 140 to automatically classify a social connection for the members 102-1, 102-2 based on the social identifiers 120. The embodiments are not limited in this context.

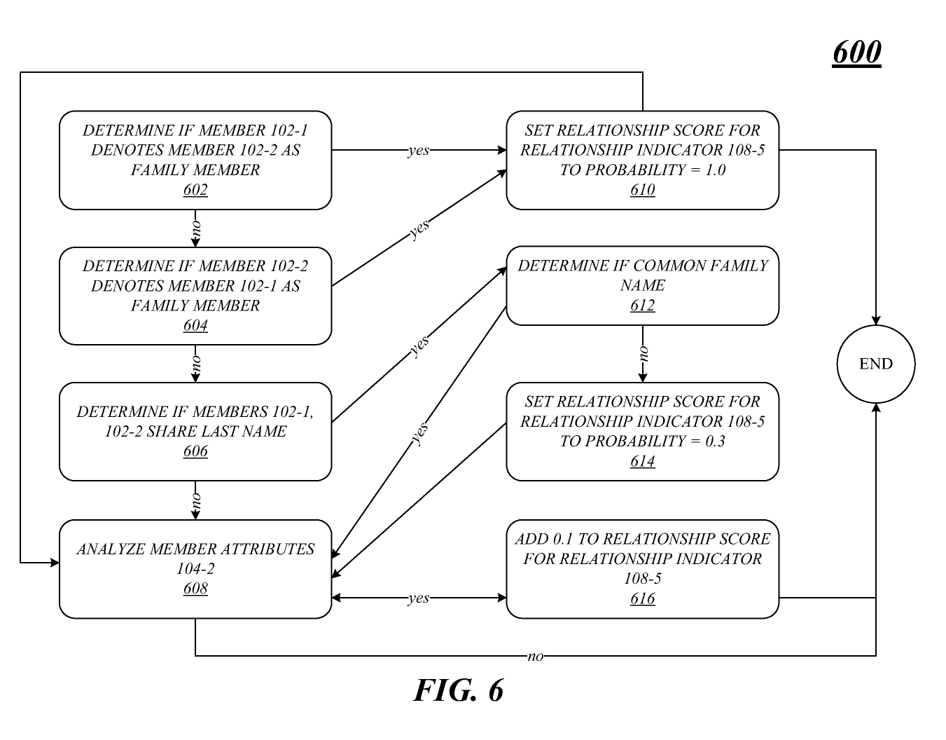

FIG. 6 illustrates one embodiment of a logic flow 600. The logic flow 600 may be representative of some or all of the operations executed by one or more embodiments described herein, such as the social monitor component 130 of the social networking systems 100, 200, for example.

In the illustrated embodiment shown in FIG. 6, the logic flow 600 may determine if the member 102-1 denotes the member 102-2 as a family member at block 602. For example, the social monitor component 130 may receive the member attribute 104-1 representing metadata for the member 102-1. The social monitor component 130 may analyze the metadata for a metadata tag indicating the member 102-2 is of a social connection type “Family.” If yes at block 602, the social monitor component 130 may set a relationship score for the relationship indicator 108-5 to a probability of 100% (or 1.0) at block 610. The social monitor component 130 may then send the relationship indicator 108-5 to the social analysis component 110 for processing.

If no at block 602, the social monitor component 130 may perform the same operation for the member 102-2 described with block 602 at block 604. If yes at block 604, the social monitor component 130 may set a relationship score for the relationship indicator 108-5 to a probability of 100% (or 1.0) at block 610. The social monitor component 130 may then send the relationship indicator 108-5 to the social analysis component 110 for processing since the probability score of the indicator 108-5 has been maximized at 100%. Additionally or alternatively, the social monitor component 130 may pass control to block 608 to process additional member attributes 104-2, 104-3 . . . 104-b. This may occur when attempting to further refine a social connection type of “Family” to more specialized social connection types defined for a managed taxonomy of the social networking systems 100, 200, such as “Family/Sibling,” “Family/Spouse,” “Family/Child,” and so forth.

If no at block 604, the social monitor component 130 may analyze other member attributes 104-2, 104-3 . . . 104-b to increase or decrease the relationship score for the relationship indicator 108-5. For instance, the social monitor component 130 may analyze additional metadata for the members 102-1, 102-2 from the member attribute 104-1 to determine whether the members 102-1, 102-2 share a last name at block 606. If yes at block 606, the social monitor component 130 may determine whether the common last name is a common family name at block 612. If yes at block 612, the social monitor component 130 may discard this information as non-probative, and analyze another member attribute 104-2, 104-3 . . . 104-b at block 608.

If no at block 612, assuming a relationship score of 0% (or 0.0) for the relationship indicator 108-5, the social monitor component 130 may set a relationship score for relationship indicator 108-5 to a probability value of 30% (0.3) at block 614. Additionally or alternatively, the social monitor component 130 may add a probability value of 30% (0.3) to an existing relationship score (e.g., greater than 0.0) for the relationship indicator 108-5 at block 614. Control may pass to the block 608 to analyze another member attribute 104-2, 104-3 . . . 104-b.

The social monitor component 130 may analyze a member attribute 104-2, 104-3 . . . 104-b other than the member attribute 104-1 at block 608. For instance, the social monitor component 130 may receive and analyze communications for the one or both members 102-1, 102-2 as indicated by the media attribute 104-2. If the social monitor component 130 detects a marked increase in message traffic (e.g., messages 302) between the members 102-1, 102-2 during holidays traditionally celebrated by families, such as Thanksgiving or Christmas, the social monitor component 130 may add a probability value of 10% (or 0.1) to the existing relationship score of 30% (or 0.3) for the relationship indicator 108-5 to form a total relationship score of 40% (or 0.4) at block 616. Operations for the blocks 608, 616 may continue for additional member attributes 104-3, 104-4 . . . 104-b until a terminating condition is reached. Examples of a terminating condition may be the relationship score for the relationship indicator 108-5 reaching a defined threshold value (e.g., 80%), running out of member attributes, time expiration, identifying specific social connection types, and so forth. The social monitor component 130 may then send the relationship indicator 108-5 to the social analysis component 110 for processing.

FIG. 7 illustrates an embodiment of an exemplary computing architecture 700 suitable for implementing various embodiments as previously described. The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors. Dual microprocessors and other multi-processor architectures may also be employed as the processing unit 704. The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures.

The system memory 706 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. The one or more application programs 732, other program modules 734, and program data 736 can include, for example, software elements of the social networking systems 100, 200, the client systems 310, 400, and the server system 330.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, and so forth. The embodiments, however, are not limited to implementation by the communications architecture 800.

As shown in FIG. 8, the communications architecture 800 comprises includes one or more clients 802 and servers 804. The clients 802 may implement the client systems 310, 400. The servers 804 may implement the server system 330. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 may communicate information between each other using a communication framework 806. The communications framework 806 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 802 and the servers 804 may include various types of standard communication elements designed to be interoperable with the communications framework 806, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 802 and a server 804 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
receiving a list of members in a social network;
receiving at least one relationship indicator derived from multiple member attributes of a member; and
generating a social identifier representing a social connection type for a social connection or potential social connection based on the relationship indicator.

2. The computer-implemented method of claim 1, comprising generating the at least one relationship indicator from the member attributes of the member.

3. The computer-implemented method of claim 1, comprising generating the at least one relationship indicator from the member attributes of the member, including a member attribute comprising metadata of the member.

4. The computer-implemented method of claim 1, comprising generating the at least one relationship indicator from the member attributes of the member, including a member attribute comprising communications of the member.

5. The computer-implemented method of claim 1, comprising generating the at least one relationship indicator from the member attributes of the member, including a member attribute comprising interests of the member.

6. The computer-implemented method of claim 1, comprising generating the at least one relationship indicator from the member attributes of the member, including a member attribute comprising activities of the member.

7. The computer-implemented method of claim 1, comprising generating the at least one relationship indicator from the member attributes of the member, including a member attribute comprising locations for the member.

8. The computer-implemented method of claim 1, comprising generating a social identifier for the social connection when the members have a social connection, the social identifier representing a social connection type for the social connection.

9. The computer-implemented method of claim 1, comprising classifying the social connection or the potential social connection based on the social identifier.

10. The computer-implemented method of claim 1, comprising:
determining the members have a social connection; and
classifying the social connection based on the social identifier.

11. The computer-implemented method of claim 1, comprising:
determining the members have a potential social connection based on the social identifier;
presenting a recommendation to create a social connection; and
creating a social connection in response to a control directive.

12. An article comprising a storage medium containing instructions that if executed enable a system to receive a list of member attributes for members in a social network, generate one or more relationship scores from the member attributes, each relationship score representing a probability of a relationship between the members, and generate relationship indicators with the relationship scores.

13. The article of claim 12, further comprising instructions that if executed enable the system to generate a relationship score from each of the member attributes, the member attributes comprising metadata for a member, a communication of a member, an interest of a member, an activity of a member, or a location of a member.

14. The article of claim 12, further comprising instructions that if executed enable the system to receive the relationship indicator for the members, and generate a social identifier for a social connection or potential social connection based on the relationship indicator.

15. The article of claim 12, further comprising instructions that if executed enable the system to determine whether the members have a social connection or a potential social connection, create a social connection when the members have a potential social connection, and classify the social connection based on the social identifier.

16. An apparatus, comprising:
a processor; and
a memory communicatively coupled to the processor, the memory operative to store a social analysis component that when executed by the processor is operative to receive a list of members in a social network, receive at least one relationship indicator derived from multiple member attributes of a member, and generate a social identifier based on the relationship indicator, the social identifier representing a social connection type for a social connection or potential social connection between two or more members of the list of members in the social network.

17. The apparatus of claim 16, comprising a social monitoring component operative to receive a list of member attributes for one or more of the members, generate a relationship score from the member attributes, the relationship score representing a probability of a relationship between a pair of members, and generate the at least one relationship indicator with the relationship score.

18. The apparatus of claim 16, comprising a social classifier component operative to classify the social connection based on the social identifier.

19. The apparatus of claim 16, comprising a social recommendation component operative to determine whether the members have a potential social connection based on the social identifier when the members do not have a social connection, present a recommendation to create a social connection based on the potential social connection and the social identifier, and receive a control directive indicating the potential social connection should be converted to a social connection.

20. The apparatus of claim 16, comprising a social formation component operative to receive a potential social connection based on the social identifier, and convert the potential social connection to a social connection.
